(19) United States
(12) Patent Application Publication
(10) Pub. No.: US 2010/0258684 A1
(43) Pub. Date: Oct. 14, 2010

(54) Support for tubing and method of using same

(76) Inventor: Guillaume Hugo Marquis-Martin, Montreal (CA)

Correspondence Address: RICHES, MCKENZIE & HERBERT, LLP, SUITE 1800, 2 BLOOR STREET EAST, TORONTO, ON, M4W 3J5, CA

(21) Appl. No.: 12/385,630

(22) Filed: Apr. 14, 2009

(51) Int. Cl. F16L 3/02

(52) U.S. Cl. 248/67.7

(57) ABSTRACT

A stand formed of two identical halves for holding tubing of different diameter is disclosed. The support has a securing mechanism to secure the two halves at different relative distances from one another. Each of the halves of the stand have a corresponding clamping surface. When the two clamping surfaces of the two halves are secured together with the clamping surfaces facing each other, the clamping surfaces form a clamp to hold the tubing. The two halves can be secured at different relative distances from one another to accommodate tubes of different diameters between the clamping surfaces. The clamping surfaces have an arcuate portion which hold the centre of the tubing a predetermined distance from the base of the stand regardless of the diameter of the tubing. The stand can be attached to a cement form during building construction to hold the tubing a predetermined distance above the cement form.

### FIELD OF THE INVENTION

This invention relates to supports to hold tubing or piping, such as supports for holding tubing or piping a predetermined distance from a concrete form prior to concrete being poured. More particularly, the invention relates to a stand to hold electrical non-metallic tubing (ENT) of various diameters a predetermined distance from the cement form.

### BACKGROUND OF THE INVENTION

In the past, electrical non-metallic tubing (ENT) of various types have been used to run electrical cable. Typically, the ENT is tied to components, such as reinforcing bars or rebar or other components, prior to the concrete being poured during building construction. Typically, the ENT will be tied to the rebar at a distance sufficiently away from the cement forms to ensure that the ENT does not extend outside of the cement once the form is removed. Also, the ENT must be tied to ensure that it does not float upwards or otherwise be displaced when the cement is poured. Without proper support, ENT may droop down or create waves, either up, down or sideways, which makes it difficult to pull cable trough the ENT after the cement has been poured and cured. Without proper support, it is also possible that ENT could be displaced before or during pouring of concrete, which may affect the ENT and possibly other elements embedded in the concrete during building construction.

The difficulty with the prior art system of tying the ENT to the rebar is that additional time is required to perform this tying action. Furthermore, it is necessary to find rebar that is at the proper height and location and not being used for another purpose in order to tie the ENT thereto. Furthermore, with post tensioned concrete slabs, which involve a series of cables or tendons tightened after the pouring of concrete, there are fewer rebars which can be used for tying ENT.

Accordingly, there is a need in the art for a device and a method to support ENT with respect to a concrete form so as to prevent the ENT from drooping down or floating up or otherwise creating waves therein which can make pulling the cable through the ENT later more difficult. Furthermore, there is a need in the art to provide a device and method which does not involve, or affect, other structural elements to be embedded within the concrete, such as steel rebar or post-tension cables. Furthermore, there is a need in the art for a device and method to quickly and efficiently install ENT. There is also a need in the art for a device and method which can efficiently install ENT having different diameters.

### SUMMARY OF THE INVENTION

Accordingly, it is an object of this invention to at least partially overcome some of the disadvantages of the prior art. Also, it is an object of this invention to provide an improved device and method for supporting tubing and, in particular, electrical non-metallic tubing (ENT) within concrete forms which does not involve tying the ENT to other components, such as structural elements, including steel rebar or post-tension cables, within the concrete slab.

Accordingly, in one of its aspects, this invention resides in a support for holding tubing, said support comprising: a first body having a first clamping surface for contacting the tubing; a second body having a second clamping surface for contacting the tubing and co-operating with the first clamping surface to form a clamp around the tubing; a securing mechanism for securing the first body to the second body with the first clamping surface facing the second clamping surface to form the clamp for holding the tubing between the first clamping surface and the second clamping surface; wherein, when the tubing is placed between the first clamping surface facing the second clamping surface and in contact therewith, the securing mechanism secures the first body to the second body to form the clamp for holding the tubing.

In a further aspect, the present invention resides in a method for support tubing with respect to a cement form, said method comprising: providing a first body having a first clamping surface; providing a second body having a second clamping surface; placing the tube between the first clamping surface and the second clamping surface; moving the first body towards the second body until the first clamping surface and the second clamping surface form a clamp to hold the tubing; and securing the first body to the second body while the clamp is holding the tube.

In a still further aspect, the present invention resides in a support for holding tubing a predetermined distance from a surface of a cement form prior to cement being poured, said support comprising: a first body having a first base with a first contact surface for contacting the cement form and a first clamping surface for contacting the tubing; a second body having a second base with a second contact surface for contacting the cement form and a second clamping surface for contacting the tubing and co-operating with the first clamping surface to form a clamp around the tubing; a security mechanism for securing the first body to the second body with the first clamping surface facing the second clamping surface to form the clamp for holding the tubing there between, said securing mechanism securing the first body to the second body at different relative distances; wherein the tubing is placed between the first clamping surface and the second clamping surface and the securing mechanism secures the first body to the second body at a relative distance such that the first clamping surface and the second clamping surface are in contact and holding the tubing; and wherein the first contact surface and the second contact surface contact the surface of the cement form to hold the tubing the predetermined distance with respect to the surface of the cement form.

In a further aspect, the present invention resides in a body securable to an identical other body to form a support holding tubing, said body comprising: a clamping surface for facing a clamping surface of the other identical body and co-operating therewith to form a clamp extending along a clamp axis for holding the tubing; a lateral support extending along a lateral axis perpendicular to the clamp axis, said lateral support co-operating with a lateral support on the other identical body to support the tubing; a part of a securing mechanism for securing the body to the other identical body with the clamping surface facing the clamping surface of the other identical body and the tubing placed there between, said part of the securing mechanism co-operating with an identical part of the securing mechanism on the other identical body to secure the body to the other identical at a relative distance corresponding to a diameter of the tubing.

Accordingly, one advantage of the present invention is that the support comprises two separate halves which can be secured together to form a clamp around the ENT. In this way, the ENT can be supported above the form without the need to tie the ENT to a structural element, such as rebar, prior to the concrete being poured. Typically, this may save the contractor approximately 40% of the electrical non-metallic tubing installation time.

A further advantage of the present invention is that the first body and the second body of the support can be secured at different relative distances from one another. In this way, ENT of different diameter can be supported with respect to the form using the same type of support, further decreasing installation costs and improving the ease of installation.

A further advantage of at least one preferred embodiment of the present invention is that the first body and the second body are substantially identical. This decreases the number of parts that are required to be purchased as a single part of a single type of stand can be purchased and assembled in the field. This also decreases the potential cost of using the device because breakage of one body of the support does not automatically preclude use of the other body, which would not be the case if the two halves were different.

A further advantage of the present invention is that the support has tapering legs to support the ENT which legs narrow to a base having a contact surface area with the cement form of, preferably, less than one-quarter square inch and, more preferably, only about one-eighth of a square inch. This decreases the amount of exposed surface area of the stand on the cement caused by the support when the form is removed after the cement is cured.

A further advantage of the present invention is that the support extends along a clamping distance in the longitudinal clamping axis of the clamp formed by the two halves. In this way, the support is designed to support ENT over a clamping distance of one inch and, preferably, up to one and one half inches instead of at a single point, as would be the case, for example, if the ENT was tied to rebar as is done in the prior art. This additional support along the clamping distance reduces the overall drooping effect of the ENT and improves the ability to use the ENT after the cement is poured and cured.

A further advantage of the present invention is that the volume of the material used for the support is relatively small, such as 15 cubic centimetres (cc) to 25 cc per side or 30 cc to 50 cc for the assembled unit. More preferably, the volume of material is about 22 cc for each side and 45 cc for the completed unit. This decreases the material cost to make the support. This also decreases the impact on the mechanical strength of the concrete slab resulting from the stand remaining in the concrete after the cement has been poured and cured.

Another advantage of one aspect of the present invention is that it is designed to withstand the weight of a worker. On a typical jobsite, workers may be walking over everything without regard as to what they may be stepping on, including ENTs, fittings and the supports therefor. Therefore, by having the support designed to withstand not only the weight of the ENT, but also the weight of a worker, less damage occurs on the jobsite while the ENT is being placed and prior to the cement being poured.

Further aspects of the invention will become apparent upon reading the following detailed description and drawings, which illustrate the invention and preferred embodiments of the invention.

### BRIEF DESCRIPTION OF THE DRAWINGS

In the drawings, which illustrate embodiments of the invention:

FIG. 1 is a perspective view showing the support having the two identical halves according to one preferred embodiment of the invention prior to the halves being secured around a pipe and attached to a surface;

FIG. 2 shows the support of FIG. 1 with the two halves of the support secured to each other with a pipe there between;

FIG. 3 shows the support of FIG. 2 with the two halves of the support secured to each other but without a pipe there between;

FIG. 4 shows a support according to one preferred embodiment secured to a pipe having a smaller diameter;

FIG. 5 shows a support according to one preferred embodiment secured to a pipe having a maximum diameter;

FIG. 6 shows one body of the support according to one preferred embodiment with pipe of different diameter shown in dotted lines;

FIG. 7 is a bottom perspective view of the securing mechanism according to one preferred embodiment;

FIG. 8 is a bottom perspective view of the support showing the securing mechanism moved together to accommodate pipes of smaller diameter than the maximum diameter;

FIG. 9 shows an alternate embodiment of the present invention with angular surfaces; and

FIG. 10 shows a further embodiment of the present invention.

### DETAILED DESCRIPTION OF THE PREFERRED EMBODIMENTS

Preferred embodiments of the invention and its advantages can be understood by referring to the present drawings. In the present drawings, like numerals are used for like and corresponding parts of the accompanying drawings.

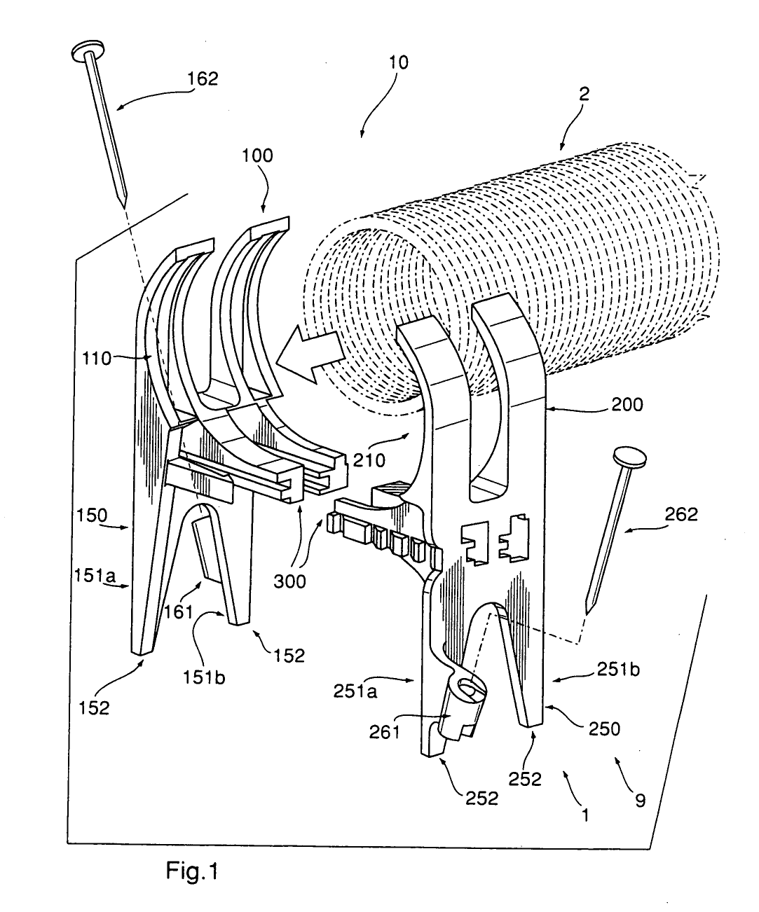

As shown in FIG. 1, one embodiment of the present invention relates to a support, shown generally by reference numeral 10, for supporting a tubing, shown generally in a dot dash line and identified by reference number 2. It is understood that the tubing 2 may extend for an indeterminate distance on both ends. The tubing 2 is shown as ending before the support 10 in FIG. 1 for illustration purposes only. In a preferred embodiment, the support 10 will be used to hold electrical non-metallic tubing (ENT) above a surface 1 such as a cement form 9, but, it is understood that the invention is not limited in this regard.

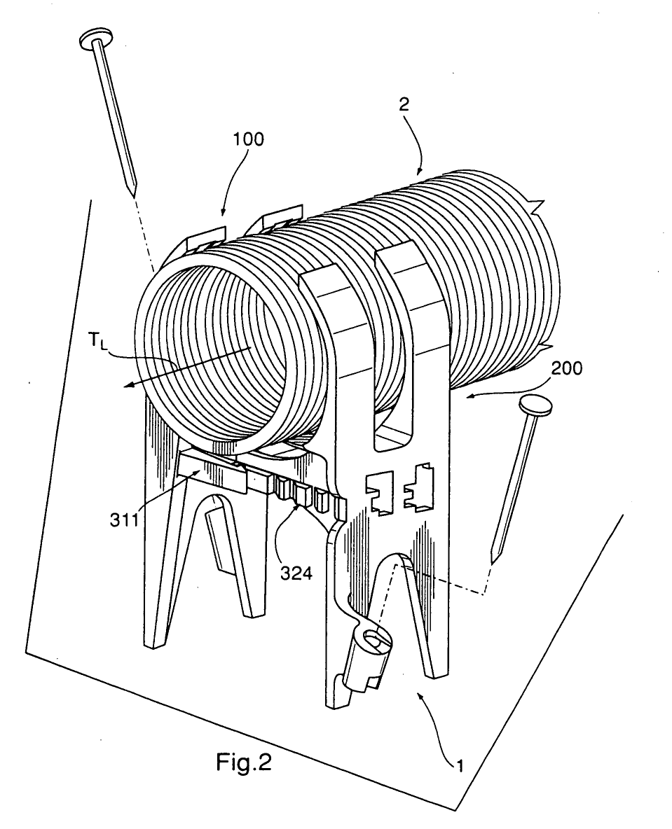

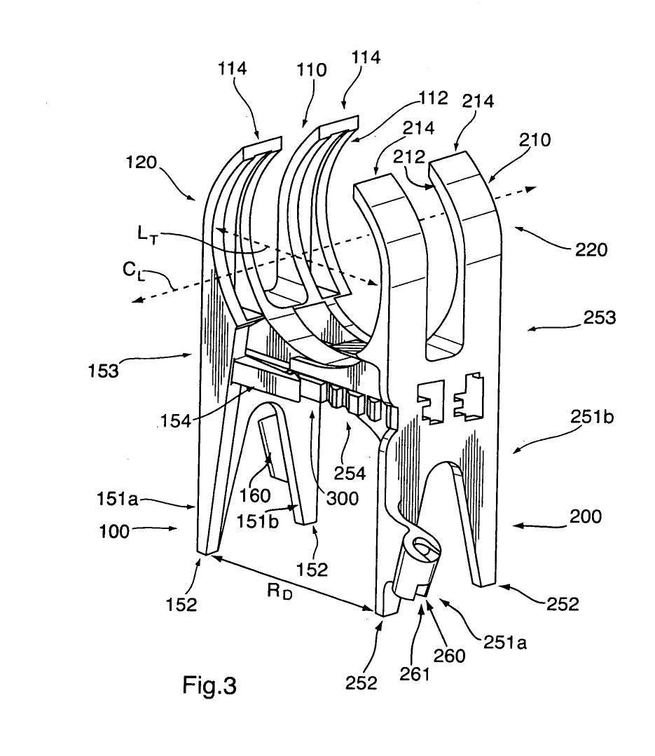

In a preferred embodiment, the support 10 comprises a first body 100 having a first clamping surface 110 for contacting the tubing 2 and a second body 200 having a second clamping surface 210 for contacting the tubing 2 and cooperating with the first clamping surface 110 to form a clamp 30 around the tubing 2. The clamp 30 is better shown in FIGS. 2 and 3 where the first body 100 is shown secured to the second body 200. Furthermore, the clamp 30 has a clamp axis CL extending longitudinally between the first and second clamping surfaces 110, 210. The tubing 2 also has a tubing longitudinal axis TL. When the tubing 2 is held in the clamp 30 between the first clamping surface 110 and the second clamping surface 210, the tube longitudinal axis TL is substantially aligned with the clamp longitudinal axis CL.

The support 10 further comprises a securing mechanism, generally shown by reference numeral 300 as shown in FIG. 1. The securing mechanism 300 secures the first body 100 to the second body 200 with the first clamping surface 110 facing the second clamping surface 210 to form the clamp 30 for holding the tubing 2 between the first clamping surface 110 and the second clamping surface 210. The securing mechanism 300 can secure the first body 100 to the second body 200 using any known means. In a preferred embodiment, as discussed more fully below, the securing mechanism 300 may comprise a plurality of indentations 314, 324 which interact with hooking mechanisms 311, 321 to hold the first body 100 at a predetermined relative distance R_{D} measured along the lateral axis LA with respect to the second body 200. In this way, when the tubing 2 is placed between the first clamping surface 110 facing the second clamping surface 210 and the tubing 2 is in contact with the two surfaces 110, 210, the securing mechanism 300 secures the first body 100 to the second body 200 to form the clamp 30 for holding the tubing 2. It is understood that any type of securing mechanism 300 for securing the first body 100 at a predetermined relative distance R_{D} with respect to the second body 200 can be used. Such securing mechanisms 300 may include a tie fastener, a nut and bolt fastener, glue, an adhesive tape, etc. One advantage of the securing mechanism 300 comprising a plurality of indentations 314, 324 and hooking mechanisms 311, 321 is that additional components are not required. Furthermore, the first body 100 and second body 200 can be made identical to each other such that one single part can be used to form the support 10.

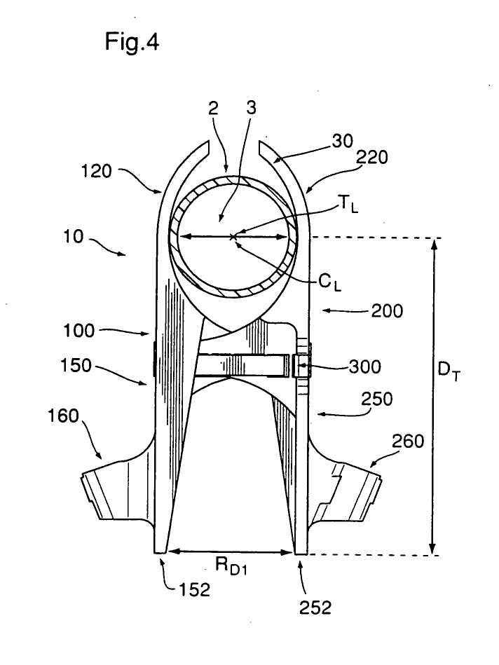

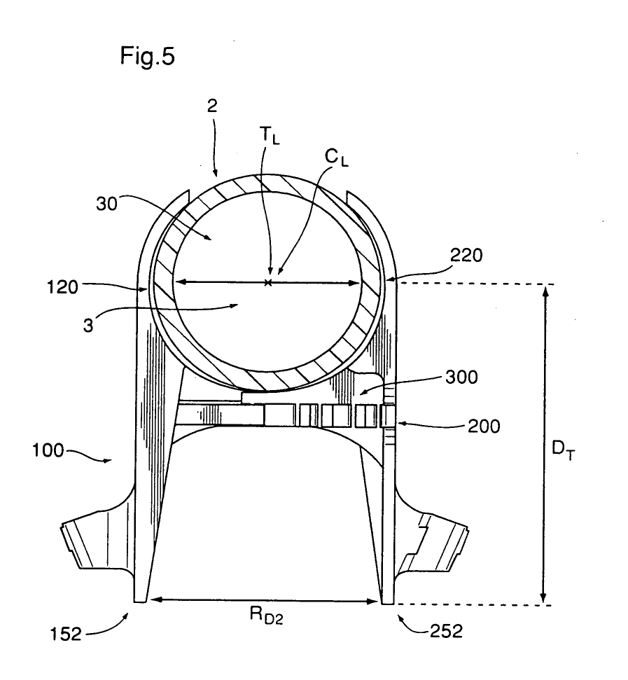

The two or more predetermined relative distances R_{D} preferably correspond to two or more different standard diameters 3 of tubing 2 to be held between the first clamping surface 110 and the second clamping surface 210. In this way, when the tubing 2 is placed between the first clamping surface 110 and the second clamping surface 210, the securing mechanism 300 may secure the first body 100 to the second body 200 at a predetermined relative distance R_{D} corresponding to a diameter 3 of the tubing 2 held between the first clamping surface 110 and the second clamping surface 210. As illustrated, for instance, in FIGS. 4 and 5, the predetermined relative distance R_{D1} shown in FIG. 4 is less than the predetermined relative distance R_{D2} shown in FIG. 5 reflecting that the diameter 3 of the tubing 2 in FIG. 4 is smaller than the diameter 3 of the tubing 2 in FIG. 5. Thus, the predetermined relative distances R_{D} may correspond to the different diameters 3 of the tubing 2 held between the first clamping surface 110 and the second clamping surface 210.

Preferably, when the securing mechanism 300 secures the first body 100 to the second body 200, the clamping surfaces 110, 210 are in contact with the tubing 2 on either side of the tubing 2 as illustrated, for instance, in FIGS. 4 and 5. Furthermore, it is preferably that the second body 200 biases the tubing 2 against the first body 100.

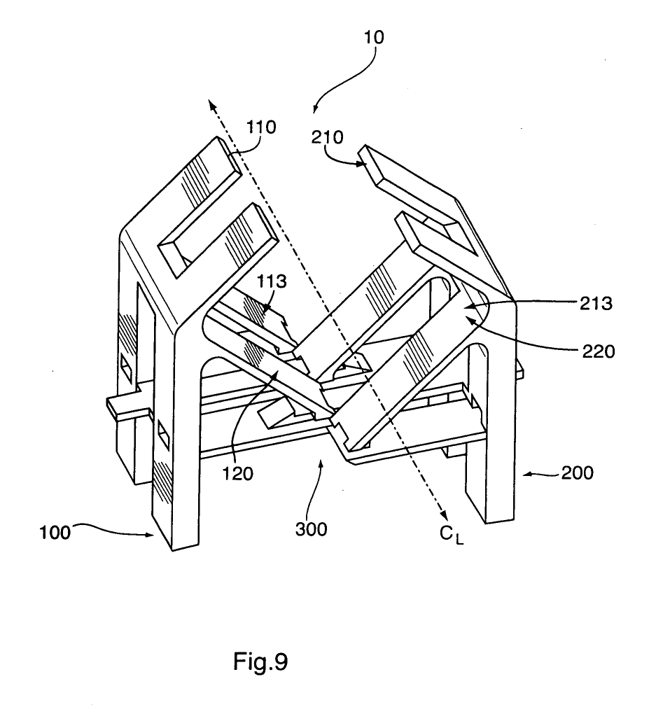

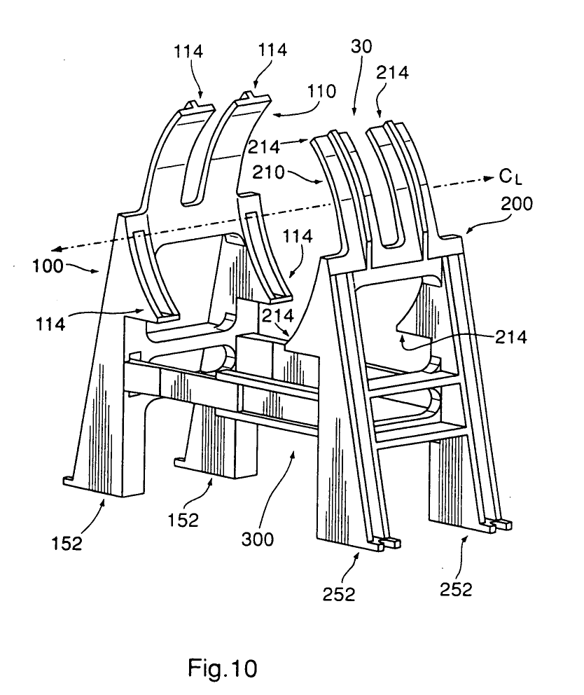

As illustrated in FIG. 3, the first clamping surface 110 may have an arcuate surface 112. Similarly, the second clamping surface 210 may have a second arcuate surface 212. Other embodiments, as illustrated, for instance, in FIG. 9, may have different types of clamping surfaces 110, 210. For instance, as illustrated in FIG. 9, the first and second clamping surfaces 110, 210 may comprise first and second angular surfaces 113, 213. The angular surfaces 113, 213 are not arcuate but, rather, comprise angular surfaces that meet at a point. It is preferred that at least one of the clamping surfaces 110, 210, comprise a remote portion 120, 220, which is furthest from the other surface 210,110 as measured along a lateral axis LT which extends perpendicular to the clamping axis CL and preferably parallel to the same axis surface 1, as shown, for instance, in FIG. 1.

The first remote portion 120 along the first clamping surface 110, being furthest or most remote from the second clamping surface 220 measured along the lateral axis LT perpendicular to the clamp axis CL, permits the tubing 2 to be biased towards that position when the securing mechanism 300 secures the second body 200 to the first body 100. In this way, the position of the tubing 2 along the first clamping surface 110, and, therefore, the surface 1 can be more easily determined because the second clamping surface 210 will bias the tubing 2 towards the first remote portion 120 furthest or most remote from the second clamping surface 210. It is also apparent that the shape of the second clamping surface 210 is not that crucial in this regard as most shapes, including a flat shape, would tend to bias the tubing 2 towards the first remote portion 120. In a preferred embodiment, however, as illustrated in the drawings and discussed above, the second arcuate surface 212 would also have a second remote portion 220, which is furthest from the first clamping surface 110 measured along the lateral axis LT when the first body 100 is secured to the second body 200.

Comparing FIGS. 4 and 5, having tubing 2 of different diameters 3, it is apparent that when the first body 100 is secured to the second body 200, the second clamping surface 210 biases the tubing to the first remote portion 120 such that the tube longitudinal axis TL is substantially the same predetermined distance D_{T} from the first and second contact surfaces 152, 252 for different diameters 3 of tubing 2. Thus, the shape of the first clamping surface 110, and having the tube 2 biased towards the first clamp surface 110 by the second clamping surface 210, assists in orienting the tubing 2 to the same predetermined distance D_{T} from the contact surfaces 152, 252 and, therefore, the surface 1 regardless of the diameter 3 of the tubing 2. This facilitates installation of the tubing 2 using the support 10 during construction. In particular, when the support 10 is used in a concrete form into which concrete will be poured and cured by ensuring that the tubing 2 and, in particular, the longitudinal axis TL of the tubing 2 is a predetermined distance D_{T} from the contact surfaces 152, 252 and, therefore, the surface 1 of the form 9.

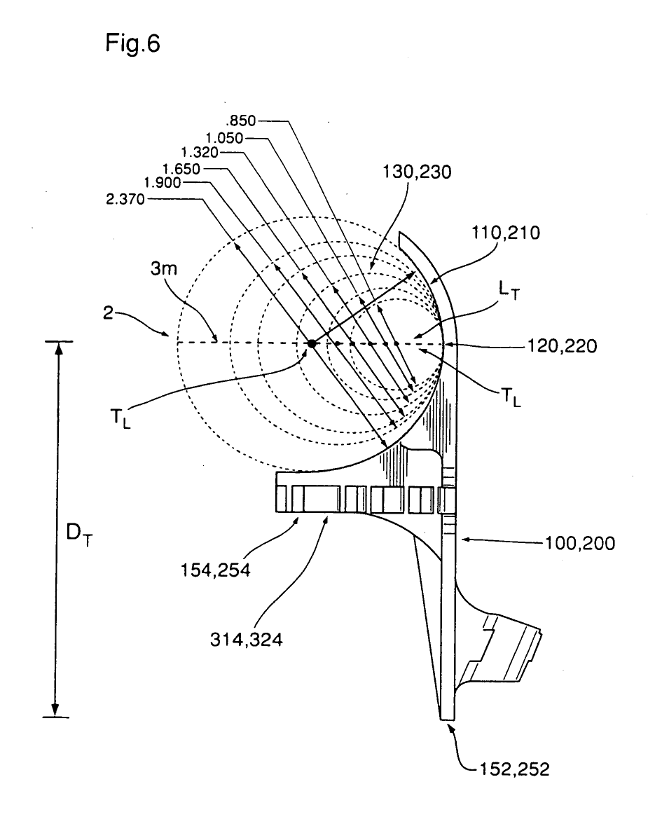

FIG. 6 illustrates the preferred embodiment where the first body 100 is identical to the second body 200. For ease of illustration, a single body 100, 200 is illustrated in FIG. 6.

FIG. 6 also shows, in dotted lines, a number of different diameter tubing 2 which could be held between two identical bodies 100, 200. As illustrated in FIG. 6, the clamping surfaces 110, 210 have a radius of curvature 130, 230 which, in this preferred embodiment, is substantially equal to or greater than a maximum diameter 3M of tubing 2 which can be held by the clamp 30.

As illustrated in FIG. 6, regardless of the diameter 3 of the tubing 2, the tubing 2 will, in all cases, contact the remote portion 120, 220, when the securing mechanism 300 secures the first body 100 to the second body 200 such that the first clamping surface 110 faces the second clamping surface 210 and they are in contact with the tubing 2 placed there between. In this way, the longitudinal axis TL of the tubing 2 will be a predetermined distance D-r from the contact surface 152, 252.

Accordingly, in a preferred embodiment, where the first body 100 is substantially identical to the second body 200, and the first body 100 is secured to the second body 200, the first clamping surface 110 biases the tubing 2 towards the second remote portion 220 such that the tube axis TL is substantially the same predetermined distance D_{T} from the second contact surface 252 for different diameters 3 of tubing 2. Similarly, the second clamping surface 210 biases the tubing 2 towards the first remote portion 120 such that the tube axis TL is substantially the same predetermined distance D_{T} from the first contact surface 152 for different diameters 3 of tubing 2.

When in this position, preferably the first and second attaching mechanisms 160, 260 are used to attach the support 10 containing the tubing 2 towards the surface 1. In a preferred embodiment, when the support 10 holds the tubing 2 with respect to a cement form 9, cement would then be poured and cured holding the support 10 and the tubing 2 in place. In a preferred embodiment, the tubing 2 may be electrical non-metallic tubing (ENT). The tubing 2 may also be other type of tubing or piping.

As illustrated in FIG. 1, the first body 100 may comprise a first attachment mechanism 160 for attaching the first body 100 to the surface 1. Preferably, the second body 200 may also have an attachment mechanism 260. In the preferred embodiment, where the first body 100 is identical to the second body 200, the first and second attachment mechanisms 160, 260 will also preferably be diagonally opposed, as illustrated for instance in FIGS. 1 and 2 further improving the stability of the support 10 when secured to the surface 1. In this way, the first attachment mechanism 160 attaches the first body 100 to the surface 1 and the second attachment mechanism 260 attaches the second body 200 to the surface 1 while the securing mechanism 300 secures the first body 100 to the second body 200 to form the clamp 30 holding the tubing 2.

The first and second attachment mechanism 160, 260 may comprise first and second tab openings 161, 261 as illustrated in FIGS. 1 and 2 that co-operate with fastening devices 162, 262, such as a nail, illustrated in FIGS. 1 and 2, or a screw, bolt or other fastening devices. However, the attachment mechanisms 160, 260, could also comprise other types of attachment mechanisms as known, for instance, glue, double sided tape, epoxy, adhesives, or the like.

Preferably, the first contact surface 152 and the second contact surface 252 contacting the cement form 9 have a total surface area which is less than ¼ of a square inch. This is preferred, because once the form 9 is removed, there is less surface area of the support 10 appearing in the cement (not shown).

In a preferred embodiment, the body 100 comprises a first base 150 which has the first contact surfaces 152. The first base 150 preferably comprises at least 2 tapering legs 151a, 151b extending from a mid-section 153 as illustrated, for instance, in FIGS. 1 and 3. Similarly, the second body 200 may comprises a mid-section 253 with at least two tapering legs 251a, 251b extending from the mid-section 253 and terminating at the second contact surface 252. In this way, the tapering legs 151, 251 permit the contact surface area 152, 252 to be relatively small and in a preferred embodiment less than ¼ of a square inch total.

As also illustrated in FIGS. 1 and 3, the first body 100 may comprise a first lateral support 154. Preferably the first lateral support 154 comprises two separate supports 154a, 154b. Similarly, the second body 200 preferably comprises a second lateral support 254 which preferably has a two separate supports 254a and 254b. The first and second lateral supports 154, 254 extend laterally from the first body 100 towards the second body 200 and from the second body 200 towards the first body 100, respectively, to improve the overall strength of the support 10 and also assist in supporting the tubing 2.

In a preferred embodiment, the securing mechanism 300 comprises a first plurality of indentations 314 on the first lateral support 154 which engage a second hooking mechanism 321 extending laterally from the second body 200 towards the first body 100, as illustrated in FIGS. 1, 3, 7 and 8. The second hooking mechanism 321 engages the plurality of indentations 314 to hold the first body 100 at the predetermined distance R_{D} with respect to the second body 200.

The hooking mechanism 321 preferably facilitates movement of the first body 100 towards the second body 200, as illustrated, for instance, by the two arrows in FIG. 8. However, the hooking mechanism 321 engages the indentations 314 to prevent movement of the first body 100 away from the second body 200. In this way, the first plurality of indentations 314 on the first lateral support 154 engage the second hooking mechanism 321 extending laterally from the second body 200 towards the first body 100 to secure the first body 100 with respect to the second body 200 at predetermined relative distances R_{D} defined by the position of the first plurality of indentations 314 on the lateral support 154.

The predetermined relative distances R_{D} correspond to diameters 3 of tubing 2 which can be held between the first clamping surface 110 and the second clamping surface 210 as described above. By knowing the standard diameters 3 of most tubing 2, the position of the plurality of indentations 314 on the lateral support 154 can be selected to ensure that the second clamping surface 210 biases the tubing 2 towards the first clamping surface 110 and, more preferably, the first remote portion 120 of the first clamping surface 110, such that the tube axis TL is substantially the same predetermined distance D_{T} from the first contact surface 152 for different diameters 3 of tubing 2. Similarly, the first clamping surface 110 will bias the tubing 2 towards the second remote portion 220 such that the tube axis TL is substantially the same predetermined distance D_{T} from the second contact surface 252 for different diameters 3 of tubing 2.

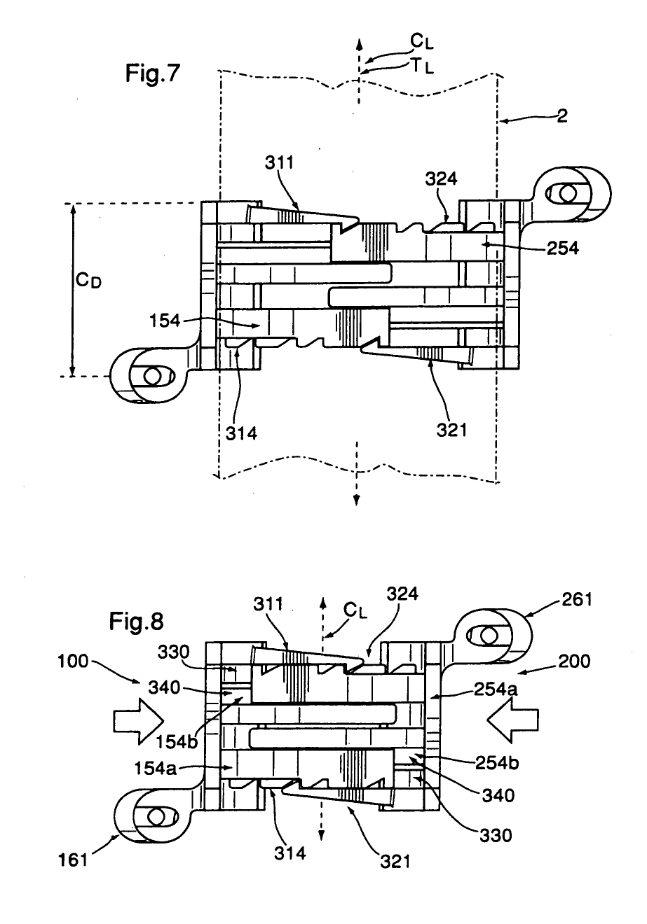

More preferably, and as would be the case if the first body 100 is substantially identical to the second body 200, the second lateral support 254 will have a second plurality of indentations 324 which engages a first hooking mechanism 311, as shown in FIGS. 7 and 8, extending laterally from the first body 100 towards the second body 200 to secure the first body 100 with respect to the second body 200 at the predetermined relative distances R_{D} defined by the second plurality of indentations 324. Preferably, the second plurality of indentations 324 on the second lateral support 254 correspond to the first plurality of indentations 314 in the first lateral support 154 such that the predetermined relative distances R_{D} defined by the second plurality of indentations 324 correspond to the predetermined relative distances R_{D} defined by the first plurality of indentations 314. In this way, the first and second plurality of indentations 314, 324 co-operate with the first and second hooking mechanisms 311, 321 to secure the first body 100 with respect to the second body 200 at the predetermined relative distance R_{D} corresponding to standard diameters 3 of tubing 2.

As illustrated in FIGS. 1, 2 and 3, the first clamping surface 110 preferably comprises at least two arms 114 extending upwards from the first mid-section 153 of the first body 100. Similarly, the second clamping surface 210 preferably comprises at least two arms 214 extending upwards from the second mid-section 253 of the second body 200. Furthermore, as illustrated best in FIG. 7, the first mid-section 153 and the second mid-section 253 extend in a direction parallel to the clamping axis CL for a clamping distance C_{D}. The clamping distance C_{D} is at least 1 inch and, more preferably, 1½ inch. In this way, the support 10 can support the tubing 2 along the tubing longitudinal axis TL for the clamping distance C_{D} which is preferably at least 1 inch and, more preferably, 1½ inches, and, in any case, more so than at a single point. This would help to avoid the tubing 2 sagging in between separate supports 10 along the concrete form 9. This could decrease the number of supports 10 that may be required to support a tubing 2 across a concrete form 9 for any appreciable distance.

In operation, the first body 100 and the second body 200 are provided as illustrated in FIG. 1. The first body 100 has the first clamping surface 110 and the second body 200 has the second clamping surface 210. The first body 100 and the second body 200 are arranged such that the first clamping surface 110 faces the second clamping surface 210. The tubing 2 is then placed between the first clamping surface 110 and the second clamping surface 210. Preferably, the lateral supports 154 may extend for an appreciable distance greater than the maximum diameter 3M of the tubing 2. This is done to assist in supporting the tubing 2 prior to the first body 100 being secured to the second body 200. This also assists in slidably co-operating the first body 100 with the second body 200.

When the tubing 2 is placed between the first clamping surface 110 and the second clamping surface 210, the first body 100 is moved towards the second body 200 as illustrated by the arrows in FIG. 8 until the first clamping surface 110 and the second clamping surface 210 form the clamp 30 to hold the tubing 2. In this position, the first clamping surface 110 and the second clamping surface 210 will be in contact with the tubing 2. Preferably, as discussed above, the second clamping surface 210 will slightly bias the tubing 2 towards the first clamping surface 110 to facilitate movement of the tubing 2 towards the first remote portion 120 and vice versa with respect to the second clamping surface 210 and the second remote portion 220, particularly in the embodiment where the first body 100 is identical to the second body 200. The first body 100 will then be secured to the second body 200 while the clamp 30 is holding the tubing 2, as discussed above. In this position, the first attaching mechanism 160 can attach the first body 100 to the surface 1 which, in a preferred embodiment, is a cement form 9, to hold the longitudinal axis TL of the tubing 2 a predetermined distance D_{T} above the form 9. If the second body 200 also has an attaching mechanism 260, the second body 200 can also be attached to the form 9 for added stability.

When the first body 100 is secured to the second body 200, the second clamping surface 210 biases the tubing 2 against the first clamping surface 110 to cause the tubing to move to the first remote position 120 in the first clamping surface 110 furthest from the second clamping surface 210 along the lateral axis LT parallel to the cement form 9 and extending between the first body 100 and the second body 200. In this way, the tube longitudinal axis TL extending along the center of the tubing 2 will be the substantially predetermined distance D_{T} from the cement form 9 regardless of the diameter 3 of the tubing 2.

Furthermore, in a preferred embodiment, where the first body 100 and second body 200 are identical, the securing mechanism 300 is integral with the first body 100 and the second body 200. Thus, because the first body 100 and the second body 200 are, in a preferred embodiment, substantially identical, only one type of body 100, 200 is required to create the support 10 for various diameters 3 of tubing 2. This decreases the installation costs by requiring only a single type of body 100, 200. This also decreases the manufacturing costs by requiring only a single mold to make a single type of body 100, 200.

In a further preferred embodiment, the lateral supports 154, 254 comprise a channel 330 which co-operates with a rail 340 as illustrated, for instance, in FIG. 8. The channels 330 and rails 340 assist in moving the first body 100 with respect to the second body 200 while it is being adjusted around the tubing 2. Furthermore, while a single channel 330 and rail 340 could be used, because the components 100 and 200 are substantially identical, corresponding channels 330 and rails 340 are created on both of the lateral supports 154a, 154b and 254a, 254b. Nevertheless, the plurality of indentations 314, 324 need only be present on one of the lateral supports 154a, 254a.

FIGS. 9 and 10 show alternate embodiments of the support 10. For instance, FIG. 9, as also discussed above, has first and second angular surfaces 113, 213. FIG. 10 has larger contact surfaces 152, 252. Also, in FIG. 10, the first clamping surface 110 has four arms 114 and the second clamping surface 210 has four arms 214. In this way, the support 10 shown in FIG. 10 may be used to support heavier tubing 2 or a piping having larger diameters 3 and/or may be used to carry heavier substances. The support 10 shown in FIG. 10 may be embedded in cement but could also be used to hold the tubing 2 in the clamp 30 along the clamp axis CL for other purposes, such as to run tubing or piping within a building.

The present invention has been disclosed with respect to tubing 2 and, in particular, electrical non-metallic tubing (ENT) having different diameters 3. It is understood that the support 10 may accommodate tubing 2 of any type of diameter 3. In particular, the ENT may have any type of diameters 3 including the standard diameters 3, such as one half inch, three-quarter inch, one inch, one and one-quarter inch, one and one-half inch and two inch. Moreover, it is understood that the support 10 is not limited to tubing 2 but can also be used for any cylindrical object, such as piping. In fact, the support 10 may be used with any pipe or tubing of SCH40, SCH80 and IPS size. Furthermore, it is understood that the support 10 may be used with any object made by extrusion including tubing, piping, cable, steel or rebar, to name a few.

To the extent that a patentee may act as its own lexicographer under applicable law, it is hereby further directed that all words appearing in the claims section, except for the above defined words, shall take on their ordinary, plain and accustomed meanings (as generally evidenced, inter alia, by dictionaries and/or technical lexicons), and shall not be considered to be specially defined in this specification. Notwithstanding this limitation on the inference of “special definitions,” the specification may be used to evidence the appropriate, ordinary, plain and accustomed meanings (as generally evidenced, inter alia, by dictionaries and/or technical lexicons), in the situation where a word or term used in the claims has more than one pre-established meaning and the specification is helpful in choosing between the alternatives.

It will be understood that, although various features of the invention have been described with respect to one or another of the embodiments of the invention, the various features and embodiments of the invention may be combined or used in conjunction with other features and embodiments of the invention as described and illustrated herein.

Although this disclosure has described and illustrated certain preferred embodiments of the invention, it is to be understood that the invention is not restricted to these particular embodiments. Rather, the invention includes all embodiments, which are functional, electrical or mechanical equivalents of the specific embodiments and features that have been described and illustrated herein.

The embodiments of the invention in which an exclusive property or privilege is claimed are defined as follows:

1. A support for holding tubing, said support comprising:
a first body having a first clamping surface for contacting the tubing;
a second body having a second clamping surface for contacting the tubing and co-operating with the first clamping surface to form a clamp around the tubing;
a securing mechanism for securing the first body to the second body with the first clamping surface facing the second clamping surface to form the clamp for holding the tubing between the first clamping surface and the second clamping surface;
wherein, when the tubing is placed between the first clamping surface facing the second clamping surface and in contact therewith, the securing mechanism secures the first body to the second body to form the clamp for holding the tubing.

2. The support as defined in claim 1 wherein the securing mechanism secures the first body to the second body at different relative distances; and
wherein, when the tubing is placed between the first clamping surface facing the second clamping surface, the securing mechanism secures the first body to the second body at a relative distance permitting the first clamping surface and the second clamping surface to hold the tubing there between.

3. The support as defined in claim 1 wherein the securing mechanism secures the first body to the second body with the first clamping surface facing the second clamping surface at two or more predetermined relative distances, said two or more predetermined relative distances corresponding to two or more different standard diameters of tubing to be held between the first clamping surface and the second clamping surface; and
wherein, when the tubing is placed between the first clamping surface and the second clamping surface, the securing mechanism secures the first body to the second body at a predetermined relative distance corresponding to a diameter of the tubing held between the first clamping surface and the second clamping surface.

4. The support as defined in claim 1 wherein the clamp has a clamp longitudinal axis extending between the first and second clamping surfaces and the tubing has a tube longitudinal axis extending along a centre of the tubing; and
wherein the tube longitudinal axis is substantially aligned with the clamp longitudinal axis when the tubing is held by the clamp.

5. The support as defined in claim 4 wherein the first clamping surface has a first remote portion located furthest from the second clamping surface measured along a lateral axis perpendicular to the clamp axis and extending between the first body and the second body; and
wherein, when the securing mechanism secures the second body to the first body, the tubing contacts the remote portion.

6. The support as defined in claim 5 wherein the second clamping surface biases the tubing to the first remote portion along the first clamping surface when the first body is secured to the second body.

7. The support as defined in claim 5 wherein the first clamping surface has a first arcuate surface defining a first radius of curvature equal to or greater than a maximum diameter of tubing which can be held in the clamp;
wherein the first remote portion corresponds to a portion of the first arcuate surface located furthest from the second clamping surface along the lateral axis.

8. The support as defined in claim 5 wherein the first body comprises a first base having a first contact surface for contacting a surface when the first body is secured to the second body; and
wherein, when the first body is secured to the second body, the second clamping surface biases the tubing to the first remote portion such that the tube axis is substantially the same predetermined distance from the first contact surfaces for different diameters of tubing.

9. The support as defined in 8 wherein the second body comprises a second base having a second contact surface for contacting the surface when the first body is secured to the second body; and
wherein the second clamping surface has a second accurate surface defining a second radius of curvature substantially equal to the first radius of curvature and the second clamping surface has a second remote portion corresponding to a portion of the second accurate surface located furthest from the first clamping surface measured along the lateral axis; and
wherein, when the first body is secured to the second body, the first clamping surface biases the tubing to the second remote portion such that the tube axis is substantially the same predetermined distance from the second contact surface for different diameters of tubing.

10. The support as defined in claim 9 wherein the first body is substantially identical to the second body.

11. The support as defined in claims 9 wherein the first body comprises a first attachment mechanism for attaching the first body to the surface.

12. The support as defined in claim 11 wherein the second body comprises a second attachment mechanism for attaching the second base to the surface; and
wherein the first attachment mechanism attaches the first body to the surface and the second attachment mechanism attaches the second body to the surface while the securing mechanism secures the first body to the second body to form the clamp holding the tubing.

13. The support as defined in claim 11 wherein the surface is a surface of a cement form, and the tube is Electrical Non-Metallic Tubing (ENT); and
wherein, when the first body is secured to the second body, and the first and second attachment mechanisms have attached the first body and the second body to the cement form, respectively, the tube axis of the ENT will be held at the same predetermined distance from the cement form for different diameters of ENT.

14. The support as defined in claim 13 wherein the first base comprises at least two tapering legs extending from a mid-section of the first body and terminating at the first contact surface; and
wherein the second base comprises at least two tapering legs extending from a mid-section of the second body and terminating at the second contact surface; and
wherein the total surface area of the first contact surface and the second contact surface contacting the cement form is less than ¼ of a square inch.

15. The support as defined in claim 4 further comprising at least:
a first lateral support extending from the first body towards and engaging the second body; and
wherein the securing mechanism comprises a first plurality of indentations on the first lateral support which engage a hooking mechanism extending laterally from the second body towards the first body to secure the first body with respect to the second body at predetermined relative distances defined by the first plurality of indentations, said predetermined relative distances corresponding to a diameter of tubing which can be held between the first clamping surface and the second clamping surface.

16. The support as defined in claim 15 further comprising:
a second lateral support extending from the second body towards the first body;
wherein the second lateral extension has a rail which engages a channel on the first lateral extension permitting relative lateral movement of the first body with respect to the second body until the hooking mechanism, extending laterally from the second body towards the first body, secures the first body with respect to the second body by engaging one of the plurality of indentations on the first lateral extension at a predetermined relative distance corresponding to the diameter of the tube held between the first clamping surface and the second clamping surface.

17. The support as defined in claim 16 wherein the securing mechanism comprises a second plurality of indentations on the second lateral support which engages a hooking mechanism extending laterally from the first body towards the second body to secure the first body with respect to the second body at predetermined relative distances defined by the second plurality of indentations, said predetermined relative distances corresponding to the predetermined relative distances of the first plurality of indentations on the first lateral support.

18. The support as defined in claim 17 wherein the first body is substantially identical to the second body.

19. The support as defined in claim 4 wherein the first clamping surface comprises at least two arms extending upwards from a first mid-section of the first body, said first mid-section extending in a direction parallel to the clamping axis for a clamping distance; and
wherein the second clamping surface comprises at least two arms extending upwards from a second mid-section of the second body extending in a direction parallel to the clamping axis for the clamping distance.

20. The support as defined in claim 19 wherein first body comprises a first base extending from the first mid-section and terminating at the first contact surface for contacting a surface of a cement form, and, the second body comprises a second base extending from the second mid-section and terminating at a second contact surface for contacting the surface of the cement form; and
wherein the tube is Electrical Non-Metallic Tubing (ENT); and
wherein the first mid-section and the second mid-section support the ENT a predetermined distance from the surface of the cement form along the clamping axis for the clamping distance.

21. The support as defined in claim 20 wherein the first body is substantially identical to the second body, and, the clamping distance is at least one inch.

22. The support as defined in claim 21 further comprising at least one attachment mechanism for attaching the support to the cement form.

23. A method for support tubing with respect to a cement form, said method comprising:
providing a first body having a first clamping surface;
providing a second body having a second clamping surface;
placing the tube between the first clamping surface and the second clamping surface;
moving the first body towards the second body until the first clamping surface and the second clamping surface form a clamp to hold the tubing; and
securing the first body to the second body while the clamp is holding the tube.

24. A method as defined in claim 23 further comprising:
attaching the first body to the cement form while the first body is secured to the second body and the clamp is holding the tube.

25. A method as defined in claim 24 wherein the first clamping surface has a first remote portion located furthest from the second clamping surface measured along a lateral axis parallel to the cement form;
wherein, when the first body is secured to the second body, the second clamping surface biases the tubing against the first clamping surface to cause the tubing to move to the first remote position on the first clamping surface furthest from the second clamping surface regardless of the diameter of the tubing such that a tube longitudinal axis extending along a centre of the tubing will be a substantially predetermined distance from the cement form regardless of the diameter of the tubing.

26. A method as defined in claim 23 wherein the securing mechanism secures the first body to the second body with the first clamping surface facing the second clamping surface at two or more predetermined relative distances, said two or more relative predetermined distances corresponding to two or more different standard diameters of tubing to be held between the first clamping surface and the second clamping surface; and
wherein the method further comprises:
securing the first body to the second body with the securing mechanism at the predetermined relative distance corresponding to the diameter of the tube placed between the first clamping surface and the second clamping surface.

27. A support for holding tubing a predetermined distance from a surface of a cement form prior to cement being poured, said support comprising:
a first body having a first base with a first contact surface for contacting the cement form and a first clamping surface for contacting the tubing;
a second body having a second base with a second contact surface for contacting the cement form and a second clamping surface for contacting the tubing and co-operating with the first clamping surface to form a clamp around the tubing;
a security mechanism for securing the first body to the second body with the first clamping surface facing the second clamping surface to form the clamp for holding the tubing there between, said securing mechanism securing the first body to the second body at different relative distances;
wherein the tubing is placed between the first clamping surface and the second clamping surface and the securing mechanism secures the first body to the second body at a relative distance such that the first clamping surface and the second clamping surface are in contact and holding the tubing; and
wherein the first contact surface and the second contact surface contact the surface of the cement form to hold the tubing the predetermined distance with respect to the surface of the cement form.

28. The support as defined in claim 27 wherein the clamp has a clamp longitudinal axis extending between the first and second clamping surfaces and the tubing has a tube longitudinal axis extending along a centre of the tubing; and
wherein the tube longitudinal axis is substantially aligned with the clamp longitudinal axis when the tubing is held by the clamp.

29. The support as defined in claim 28 wherein the securing mechanism is integrally formed with the first body and the second body.

30. The support as defined in claim 29 wherein the first body comprises a first lateral support extending from the first body to the second body and engaging the second body;
wherein the securing mechanism comprises a first plurality of indentations on the first lateral extension which engage a hooking mechanism extending laterally from the second body towards the first body to secure the first body with respect to the second body at predetermined relative distances defined by the first plurality of indentations, said predetermined relative distances corresponding to a diameter of tubing which can be held between the first clamping surface and the second clamping surface.

31. The support as defined in claim 30 further comprising:
a second lateral support extending from the second body towards the first body and engaging the first body;
wherein the second lateral extension has a rail which engages a channel on the first lateral extension permitting relative lateral movement of the first body with respect to the second body until the hooking mechanism, extending laterally from the second body towards the first body, secures the first body with respect to the second body by engaging one of the plurality of indentations on the first lateral extension at a predetermined relative distance corresponding to the diameter of the tubing held between the first clamping surface and the second clamping surface; and
wherein the securing mechanism comprises a second plurality of indentations on the second lateral extension which engages a hooking mechanism extending laterally from the first body towards the second body to secure the first body with respect to the second body at predetermined relative distances defined by the second plurality of indentations, said predetermined relative distances corresponding to the predetermined relative distances of the first plurality of indentations on the first lateral extension.

32. The support as defined in claim 31 wherein the first body is substantially identical to the second body.

33. The support as defined in claim 27 wherein the first clamping surface has a first arcuate surface having a remote portion furthest from the second clamping surface measured along a lateral axis substantially perpendicular to the clamp axis and extending between the first clamping surface and the second clamping surface; and
wherein when the tubing is placed between the first clamping surface and the second clamping surface, the relative distance between the first body and the second body is decreased causing the tube to be biased toward the first clamping surface and move towards the remote position regardless of the diameter of the tubing.

34. The support as defined in claim 33 wherein the lateral axis intersects the clamp axis and is parallel to the surface of the cement form when the first and second contact surfaces are in contact with the cement form; and
wherein the lateral axis intersects the remote portion; and
wherein the tubing moves along the first arcuate surface towards the remote portion regardless of the diameter of the tubing such that the tubing axis is substantially intersected by the lateral axis; and
wherein the distance of the lateral axis to the cement form when the first and second contact surfaces are in contact with the cement form correspond to the predetermined distance.

35. The support as defined in claim 34 further comprising an attachment mechanism to attach the support to the cement form when the first body is secured to the second body and the clamp is holding the tubing.

36. The support as defined in claim 28 wherein the first body comprises a first mid-section intermediate the first clamping surface and the base, said first mid-section extending parallel to the clamp axis for a clamp distance and supporting the tubing for the clamp distance above the cement form, said clamp distance being greater than one inch.

37. A body securable to an identical other body to form a support holding tubing, said body comprising:
a clamping surface for facing a clamping surface of the other identical body and co-operating therewith to form a clamp extending along a clamp axis for holding the tubing;
a lateral support extending along a lateral axis perpendicular to the clamp axis, said lateral support co-operating with a lateral support on the other identical body to support the tubing;
a part of a securing mechanism for securing the body to the other identical body with the clamping surface facing the clamping surface of the other identical body and the tubing placed there between, said part of the securing mechanism co-operating with an identical part of the securing mechanism on the other identical body to secure the body to the other identical at a relative distance corresponding to a diameter of the tubing.

38. The body as defined in claim 37 wherein the part of the securing mechanism comprises:
a plurality of indentations on the lateral extension which engage a hooking mechanism on the other identical body, at least one of said plurality of indentations corresponding to a diameter of tubing to be held by the clamp; and
a hooking mechanism for engaging a plurality of indentations on the other identical body.
